(19) United States
(12) Patent Application Publication
(10) Pub. No.: US 2010/0048248 A1
(43) Pub. Date: Feb. 25, 2010

(54) COMMUNICATION TERMINAL AND EXCHANGE RATE DETERMINING METHOD THEREOF

(75) Inventors: Kwang Jin Park, Suwon-si (KR); Hong Kim, Seoul (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/431,377

(22) Filed: Apr. 28, 2009

(30) Foreign Application Priority Data
Aug. 20, 2008 (KR) 10-2008-0081398

(51) Int. Cl. H04B 1/38; G06Q 40/00

(52) U.S. Cl. 455/558; 705/1

(57) ABSTRACT

A communication terminal and exchange rate determining method thereof are disclosed. The method includes determining exchange rate information according to first country information, received from Subscriber Identity Module (SIM) information of a SIM card, and second country information, received from a System Information Block (SIB) broadcast from an affiliated base station, determining exchange rate information according to the first country information and the second country information, selecting a first amount, corresponding to a first monetary unit of the first country information, determining a second amount, corresponding to a second monetary unit of a the second country information, from the selected first amount using the exchange rate information, and displaying the second amount.

### PRIORITY

This application claims the benefit under 35 U.S.C. § 119(a) of a Korean patent application filed in the Korean Intellectual Property Office on Aug. 20, 2008 and assigned Serial No. 10-2008-0081398, the entire disclosure of which is hereby incorporated by reference.

### BACKGROUND OF THE INVENTION

1. Field of the Invention

The present invention relates to communication devices. More particularly, the present invention relates to a communication terminal having a Subscriber Identity Module (SIM) card, and an exchange rate determining method thereof.

2. Description of the Related Art

As communication terminals are continuously developing, having access to the communication terminals while in different countries is becoming more important. A roaming service allows a user to communicate while in a different country using a single communication terminal. To comply with the roaming service, a conventional communication terminal has a function to calculate an exchange rate between two countries.

The conventional communication terminal, however, is disadvantageous in that it does not calculate the exchange rate until a variety of information is selected in sequence according to a communication terminal user's request. That is, only after the communication terminal user selects information related to the two countries and exchange rate information related to the two countries, the conventional communication terminal can calculate the exchange rate for a certain amount according to a monetary unit of each country. Therefore, calculating the exchange rate using the conventional communication terminal may be difficult. Furthermore, since exchange rate information fluctuates and must be provided to users, the conventional communication terminals are disadvantageous in that they may not precisely calculate exchange rates.

Therefore, a need exists for a communication terminal and an exchange rate determination method thereof that more precisely determines an exchange rate between two countries.

### SUMMARY OF THE INVENTION

An aspect of the present invention is to address at least the above-mentioned problems and/or disadvantages and to provide at least the advantages described below. Accordingly, an aspect of the present invention is to provide a communication terminal having a Subscriber Identity Module (SIM) card, and an exchange rate determining method thereof.

In accordance with an aspect of the present invention, an exchange rate determining method of a communication terminal is provided. The method includes receiving first country information from Subscriber Identity Module (SIM) information of a SIM card, receiving second country information from a System Information Block (SIB) broadcast from an affiliated base station, determining exchange rate information according to the first country information and the second country information, selecting a first amount, corresponding to a first monetary unit, determining a second amount, corresponding to a second monetary unit, from the selected first amount using the exchange rate information, and displaying the second amount.

In accordance with another aspect of the present invention, a communication terminal is provided. The terminal includes a SIM card for storing SIM information having first country information, a Radio Frequency (RF) communication unit for receiving a SIB having second country information broadcast from an affiliated base station, when power is supplied to the communication terminal, a controller for determining exchange rate information according to the first country information and the second country information, in an exchange rate determining mode, and for determining a second amount, corresponding to the second country information, from a first amount, corresponding to the first country information, using the exchange rate information when the first amount is selected, and a display unit for displaying the second amount.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a communication system according to an exemplary embodiment of the present invention;

FIG. 2 is a schematic block diagram illustrating a communication terminal according to an exemplary embodiment of the present invention;

FIG. 3 is a flowchart describing an exchange rate determining method according to an exemplary embodiment of the present invention;

FIG. 4 is a flowchart describing an exchange rate information storing mode according to an exemplary embodiment of the present invention; and

FIG. 5 is a flowchart describing an exchange rate determining mode according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to a description of exemplary embodiments of the present invention, terminologies of the description will be defined below.

Hereinafter, a ‘Subscriber Identity Module (SIM) card’ denotes a card medium to identify respective communication terminals in a communication system. The SIM card, in general, refers to a card medium for a Global System for Mobile (GSM) communications system. However, in the following description, the SIM card is used to refer to a concept that includes a Universal Subscriber Identity Module (USIM) card for a Universal Mobile Telecommunication System (UMTS), a User Identity Module (UIM) card for a Code Division Multiple Access (CDMA) system, a Removal User Identity Module (RUIM) card and the like.

The term ‘SIM information’ denotes inherent information that is stored in each SIM card to identify the SIM card with others. The SIM information includes an International Mobile Station Identity (IMSI), user authentication information, communication encryption information and the like. The IMSI includes a Mobile Country Code (MCC), a Mobile Network Code (MNC) and a Mobile Subscriber Identification Number (MSIN). The IMSI includes 15 digits, 3 digits of which indicate the MCC, 2 digits of which indicate the MNC and 10 digits of which indicate the MSIN. The MCC and the MNC are defined by standards. For example, the MCC in the SIM information may be a code indicating a country that manufactures a corresponding SIM card.

An ‘affiliated base station’ denotes a base station located in any one of a plurality of cells that include a communication system, i.e., a base station of a cell to which a particular communication terminal is affiliated with.

A ‘System Information Block (SIB)’ denotes information that is commonly required by communication terminals in a particular cell in a communication system, i.e., information that is broadcast by an affiliated base station of a corresponding cell. The SIB includes a Public Land Mobile Network (PLMN) identification number that is a combination of a Mobile Country Code (MCC) and a Mobile Network Code (MNC). For example, the MCC of the SIB may be a code indicating a country where a communication terminal is presently located.

The term ‘Country information’ denotes information assigned to respective countries to identify countries in the world. The country information may be a number corresponding to the MCC or a country name corresponding to the MCC. In this case, the country information may serve as a terminology including a monetary unit of a corresponding country.

The term ‘Exchange rate information’ denotes a rate exchanging monetary unit between two countries. When an exchange rate is determined from an amount corresponding to a monetary unit of one country to an amount corresponding to a monetary unit of another country, the country information regarding one country serves as information related to a reference country and the country information regarding the other country serves as information related to a destination country.

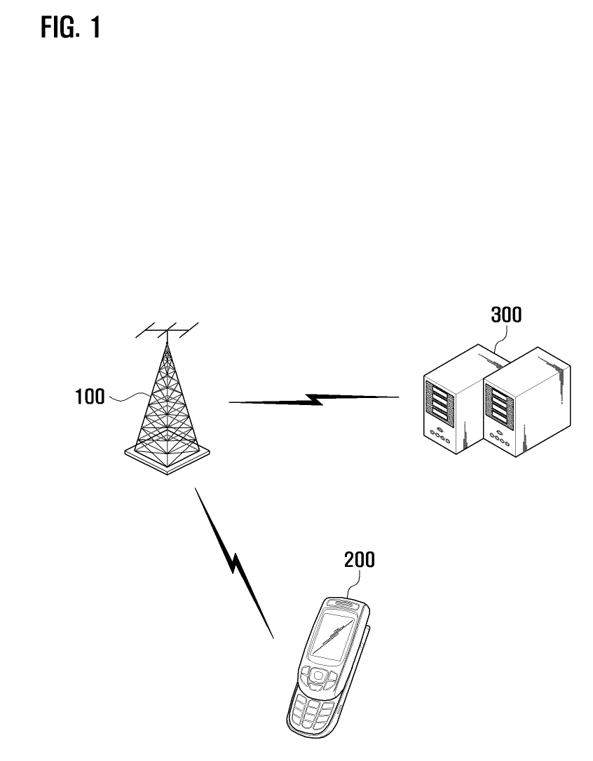

FIG. 1 is a view illustrating a communication system according to an exemplary embodiment of the present invention.

Referring to FIG. 1, the communication system includes an affiliated base station 100, a communication terminal 200 and an exchange rate server 300.

The affiliated base station 100 is located at any one of a plurality of cells in the communication system. The affiliated base station 100 broadcasts a SIB.

The communication terminal 200 receives the SIB from the affiliated base station 100 in a corresponding cell. The communication terminal 200 includes a SIM card. The SIM card may be detachably installed to the communication terminal 200. The SIM card receives first country information from SIM information of the SIM card and second country information from the SIB. The SIM card may also be operated in an exchange rate determining mode using the first country information and the second country information.

The exchange rate server 300 stores an exchange rate information list including exchange rate information according to the first country information and the second country information. The exchange rate server 300 may update the exchange rate information list at any time. The exchange rate server 300 may also provide exchange rate information or an exchange rate information list, according to the first country information and the second country information, to the communication terminal 200, according to a request of the communication terminal 200. The exchange rate server 300 may provide the exchange rate information or the exchange rate information list through a Multimedia Message Service (MMS).

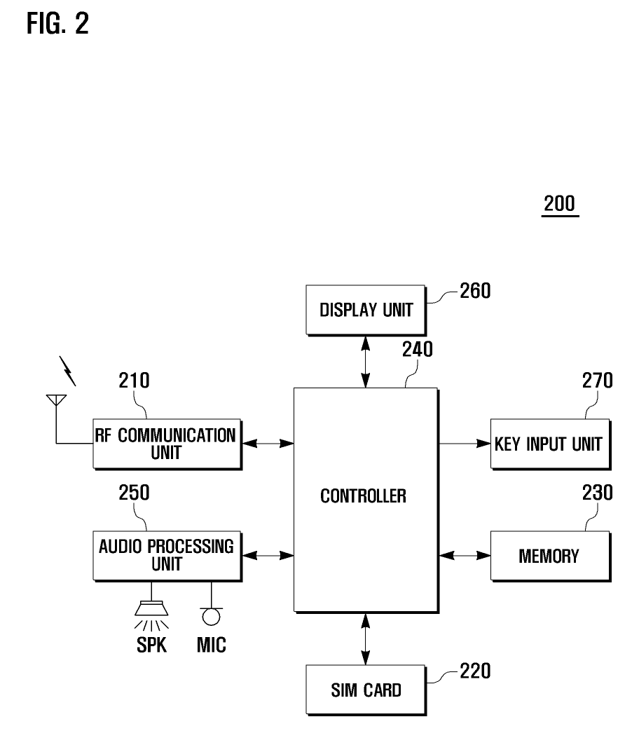

FIG. 2 is a schematic block diagram illustrating a communication terminal according to an exemplary embodiment of the present invention.

Referring to FIG. 2, the communication terminal 200 includes a Radio Frequency (RF) communication unit 210, a SIM card 220, a memory 230, a controller 240, an audio processing unit 250, a display unit 260 and a key input unit 270.

The RF communication unit 210 performs an RF communication function for the communication terminal 200. The RF communication unit 210 is configured to include an RF transmitter for up-converting the frequency of transmitted signals and amplifying the transmitted signals and an RF receiver for low-noise amplifying of received RF signals and down-converting the frequency of the received RF signals.

The SIM card 220 performs an identifying function for the communication terminal 200. The SIM card 220 is manufactured separately from the communication terminal 200, so that the SIM card 220 may be detachably installed to the communication terminal 200. The SIM card 220 stores inherent SIM information.

The memory 230 may include a program memory and a data memory. The program memory stores programs for controlling the general operation of the communication terminal 200. In an exemplary implementation, the program memory may store programs for determining exchange rates. The data memory may store data generated as the programs are executed. The memory 230 may also store an exchange rate information list.

The controller 240 controls an entire operation of the communication terminal 200. The controller 240 includes a data processor that comprises a transmitter for coding and modulating transmitted signals and a receiver for decoding and demodulating received signals. The data processor may be implemented to include a modem and a codec. The codec includes a data codec for processing packet data and the like, and an audio codec for processing audio signals, such as voice signals and the like.

In an exemplary implementation, the controller 240 is operated in an exchange rate determining mode. That is, the controller 240 receives first country information from the SIM information of the SIM card 220. The controller 240 may also receive second country information from the SIB that is broadcast from the affiliated base station 100. The controller 240 may also receive the first country information and the second country information in an exchange rate determining mode. The controller 240 may also receive the first country information when power is supplied and the second country information in an exchange rate determining mode. The controller 240 determines exchange rate information according to the first country information and the second country information in an exchange rate determining mode. The controller 240 may receive and determine exchange rate information according to the first country information and the second country information from the exchange rate server 300. The controller may also determine exchange rate information from an exchange rate information list that was received from the exchange rate server 300 and stored in the memory 230. When a first amount, corresponding to a first monetary unit of the first country information, is selected, the controller 240 determines a second amount, corresponding to a second monetary unit of the second country information, from the first amount using the determined exchange rate information.

Still referring to FIG. 2, the audio processing unit 250 plays back audio signals, output from the audio codec of the data processor, through a Speaker (SPK). The audio processing unit 250 may also output audio signals, transmitted from a Microphone (MIC), to the audio codec of the data processor.

The display unit 260 displays user data output from the controller 240. The display unit 260 may be implemented with a Liquid Crystal Display (LCD). In that case, the display unit 260 may include an LCD controller, a memory for storing video data, an LCD display device and the like. More particularly, if the LCD is implemented with a touch screen, the display unit 260 may also serve as an input unit.

The key input unit 270 is comprised of keys for receiving numerical and character information and function keys for setting various functions.

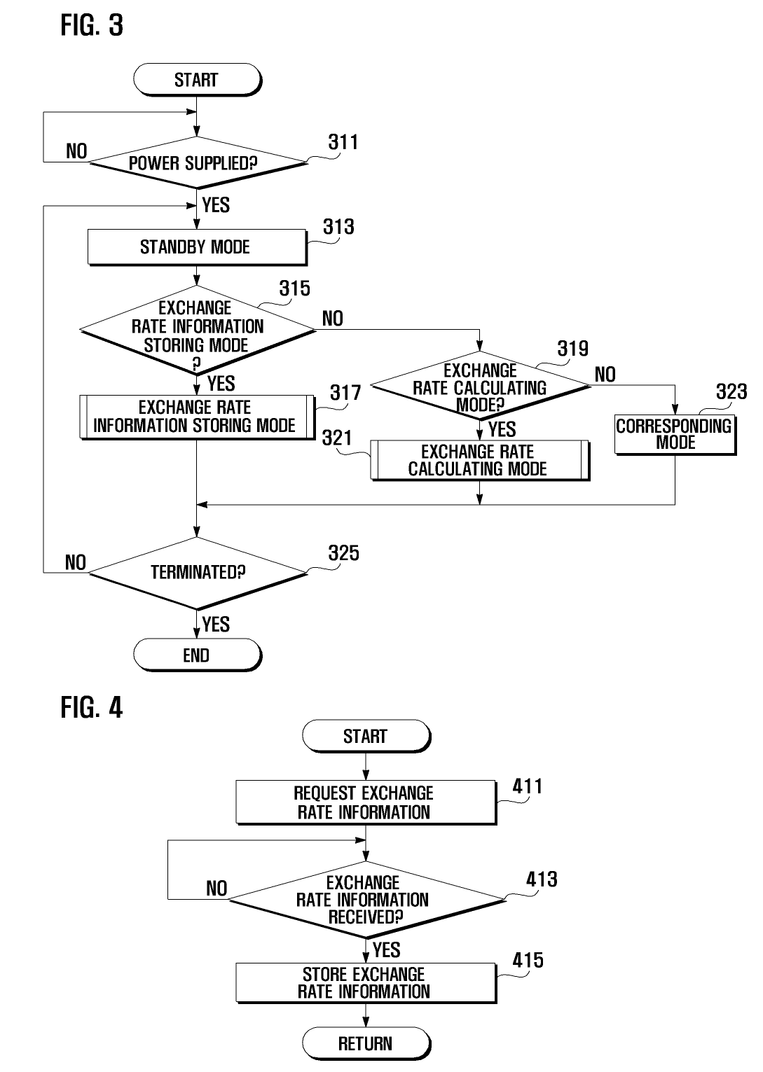

FIG. 3 is a flowchart describing an exchange rate determining method according to an exemplary embodiment of the present invention.

Referring to FIG. 3, in step S311 the controller 240 determines whether power is supplied to a communication terminal 200, in which a SIM card 220 is installed. If the controller 240 determines that power is supplied to the communication terminal 200 in step S311, the controller 240 is operated in a standby mode in step S313. During the standby mode, the controller 240 periodically receives a SIB at a certain time period.

The controller 240 determines whether an exchange rate information storing mode is requested in step S315. If the controller 240 determines that an exchange rate information storing mode is requested in step S315, the controller 240 is operated in an exchange rate information storing mode in step S317. The controller 240 may receive exchange rate information from an exchange rate server 300 and store the exchange rate information. The controller 240 may also update an exchange rate information list stored in the memory 230.

In the following description, the exchange rate information storing mode is described with reference to FIG. 4.

FIG. 4 is a flowchart describing an exchange rate information storing mode according to an exemplary embodiment of the present invention.

Referring to FIG. 4, the controller 240 requests exchange rate information from the exchange rate server 300 in step S411. That is, the controller 240 transmits an exchange rate information request to the exchange rate server 300. When the controller 240 receives the exchange rate information in step S413, the controller 240 stores the exchange rate information in step S415 and then returns to the process of FIG. 3. That is, when the controller 240 receives an exchange rate information response signal from the exchange rate server 300, the controller 240 extracts an exchange rate information list from the exchange rate information response signal and then stores the exchange rate information list in the memory 230. The exchange rate information response signal may be a multimedia message. If an exchange rate information list was previously stored in the memory 230, the exchange rate information list is updated by the controller 240.

The memory 230 may store the exchange rate information list, as illustrated in the following Table 1, under the control of the controller 240.

TABLE 1

| Reference Country | | Destination country | | |
|---|---|---|---|---|
| Info. | | info. | | |
| MCC | Monetary unit | MCC | Monetary unit | Exchange rate Info. |
| 310 | USD | 440 | JPY | 107.43 |
| | | 450 | KRW | 1008.80 |
| | | 550 | AUD | 1.04 |
| | | — | — | — |
| | | — | — | — |
| | | — | — | — |
| 550 | AUD | 310 | USD | 0.96 |
| | | 440 | JPY | 102.92 |
| | | 450 | KRW | 966.43 |
| | | — | — | — |
| | | — | — | — |
| | | — | — | — |
| — | — | — | — | — |
| — | — | — | — | — |
| — | — | — | — | — |

Referring back to FIG. 3, if the controller 240 determines that an exchange rate information storing mode is not requested in step S315, the controller 240 determines whether an exchange rate determining mode is requested in step S319. When the controller 240 determines that the exchange rate determining mode is requested in step S319, the controller 240 is operated in an exchange rate determining mode in step S321. During the exchange rate determining mode, the controller 240 determines the exchange rate using the first country information from SIM information of the SIM card 220, and the second country information from the SIB received through the RF communication unit 210. The controller 240 determines an exchange rate using the exchange rate information transmitted from the exchange rate server 300.

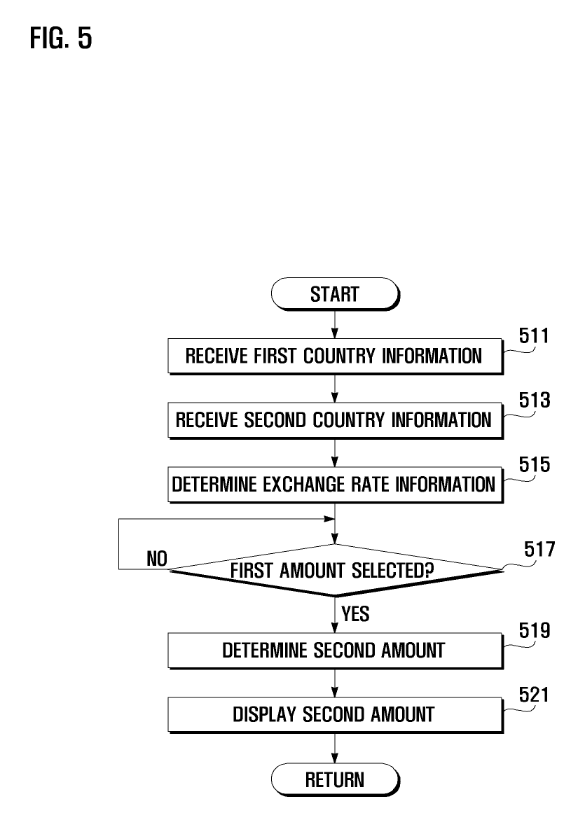

In the following description, the exchange rate determining mode is described with reference to FIG. 5.

FIG. 5 is a flowchart describing an exchange rate determining mode according to an exemplary embodiment of the present invention.

Referring to FIG. 5, the controller 240 receives the first country information from SIM information in the SIM card 220 in step S511. The SIM information includes an International Mobile Station Identity (IMSI), user authentication information, communication encryption information and the like. The IMSI includes a Mobile Country Code (MCC), a Mobile Network Code (MNC) and a Mobile Subscriber Identification Number (MSIN). The IMSI includes 15 digits, 3 digits of which indicate the MCC, 2 digits of which indicate the MNC and 10 digits of which indicate the MSIN. The MCC and the MNC are defined by standards. For example, the MCC in the SIM information may be a code indicating a country that manufactures a corresponding SIM card 220. The controller 240 may extract the MCC of the SIM information as the first country information. The controller 240 may also extract the MCC of the SIM information and determine that a country name corresponding to the MCC serves as the first country information.

The controller 240 then receives second country information from the SIB received through the RF communication unit 210 in step S513. The SIB includes a PLMN identification number that is a combination of the MCC and the MNC. For example, the MCC of the SIB may be a code indicating a country where a communication terminal is presently located. The controller 240 may extract the MCC of the system information block as the second country information. The controller 240 may also extract the MCC of the system information block and determine that a country name corresponding to the MCC serves as the second country information.

The memory 230 may store the country name corresponding to the MCC, as illustrated in the following Table 2. The memory may also store the monetary unit corresponding to the MCC.

TABLE 2
Country Info. Block

| MCC | Country Name | Monetary unit |
|---|---|---|
| 310 | United States of America | USD |
| 440 | Japan | JPY |
| 450 | Republic of Korea | KRW |
| 550 | Australia | AUD |
| — | — | — |
| — | — | — |
| — | — | — |

Next, the controller 240 determines exchange rate information according to the first country information and the second country information in step S515. The controller 240 may detect exchange rate information according to the first country information and the second country information from an exchange rate information list stored in the memory 230. The controller 240 may detect the first monetary unit corresponding to the first country information and the second monetary unit corresponding to the second country information. The controller 240 may also detect exchange rate information between the first monetary unit and the second monetary unit. For example, the controller 240 searches for the first country information as reference country information and the second country information as destination country information, from the exchange rate information list of Table 1. The controller 240 then determines exchange rate information according to the first country information and the second country information. If the first country information of the SIM information is ‘310’ and the second country information of the system information block is ‘450,’ the controller 240 may detect ‘1008.80’ as exchange rate information.

The controller 240 determines whether the first amount of the first country is selected in step S517. If the first amount is selected in step S517, the controller 240 determines the second amount of the second country to exchange with the first amount using exchange rate information according to the first country information and the second country information in step S519. For example, if ‘100’ is selected as the first amount, the controller 240 multiplies the first amount, 100, with exchange rate, 1008.80, to determine the second amount, 100880. If the first amount is not selected in step S517, the controller 240 returns to step 517 and again determines whether the first amount is selected.

The controller 240 displays the second amount of the second country in step S521, and then returns to the process of FIG. 3. More particularly, the controller 240 may display the second amount with the second monetary unit. For example, the controller 240 may display the second amount ‘100880 Won,’ where ‘Won’ indicates a Korean monetary unit.

Referring back to FIG. 3, when the controller 240 determines that the exchange rate determining mode is not requested in step S319, the controller 240 is operated in a corresponding mode in step S323. For example, the controller 240 may perform a variety of functions for the communication terminal 200.

While the communication terminal is operated in the modes as described in steps S317, S321 and S323, the controller 240 determines whether the termination of an exchange rate determining process is requested in step S325. If the controller 240 determines that the termination of an exchange rate determining process is requested in step S325, the controller 240 terminates the process. On the contrary, if the controller 240 does not detect that the termination of an exchange rate determining process is requested in step S325, the controller 240 returns to step S313 and performs the following steps thereof as described.

In an exemplary implementation, the communication terminal is implemented in such a way to determine exchange rate information and determine an exchange rate by determining first country information corresponding to reference country information and second country information corresponding to destination country information. It should be, however, understood that exemplary embodiments of the present invention are not limited thereto. That is, the exemplary embodiments of the present invention may be modified in such a way that the communication terminal determines exchange rate information and determines an exchange rate by determining the first country information serving as the destination country information and the second country information serving as the reference country information. More particularly, the exemplary embodiments of the present invention may be modified in such a way that, although the communication terminal determines exchange rate information by determining the first country information corresponding to the reference country information and the second country information corresponding to the destination country information, the controller may also determine the exchange rate information by determining the first country information corresponding to the destination country information and the second country information corresponding to the reference country information, in response to a request for mutually transforming exchange rate information between the reference country information and the destination country information.

In an exemplary implementation, although the communication terminal receives the first country information and the second country information and then determines the exchange rate, it should be understood that exemplary embodiments of the present invention are not limited thereto. That is, the exemplary embodiments of the present invention may be modified in such a way that, although the communication terminal does not enter an exchange rate determining mode, the communication terminal may receive first country information and second country information and then determine the exchange rate. For example, if a communication terminal is implemented in such a way to include a SIM card, the controller may receive the first country information when power is supplied to the communication terminal and the second country information in an exchange rate determining mode, thereby determining the exchange rate. Furthermore, the exemplary embodiments of the present invention may also be modified in such a way that, when the communication terminal receives a SIB, the controller receives the second country information.

In an exemplary implementation, the communication terminal is implemented in such a way to receive and store an exchange rate information list, separating from an exchange rate determination mode, and to determine an exchange rate in an exchange rate determining mode. It should be understood that exemplary embodiments of the present invention are not limited thereto. That is, the exemplary embodiments of the present invention may be modified in such a way that the communication terminal receives an exchange rate or an exchange rate information list in an exchange rate determining mode and then determines the exchange rate. For example, the communication terminal may be implemented in such a way to transmit an exchange rate information request signal to an exchange rate server, where the exchange rate information request signal includes the first country information that the controller receives from SIM information and the second country information that the controller receives from a SIB. When the communication terminal receives an exchange rate information response signal from the exchange rate server, the controller detects exchange rate information, according to the first country information and the second country information, from the exchange rate information response signal. Therefore, the controller may determine exchange rate using the exchange rate information according to the first country information and the second country information.

According to exemplary embodiments of the present invention, the communication terminal may receive SIM information of a SIM card. The communication terminal may also receive country information from a SIB that is broadcast from an affiliated base station. The communication terminal may then determine the exchange rate according to the received information. That is, although a communication terminal user does not select a variety of information to determine the exchange rate, the communication terminal may receive and determine a variety of information, so that the exchange rate may be easily determined. Therefore, the communication terminal may provide enhanced user convenience. The communication terminal may also determine a precise exchange rate. That is, since the communication terminal receives exchange rate information from the exchange rate server and determines the exchange rate, the communication terminal may precisely determine exchange rates using variable exchange rate information.

As described above, the exchange rate determining method determines the exchange rate information when the communication terminal receives country information from the SIM information of the SIM card and the SIB that is broadcast from a corresponding base station. Accordingly, exchange rates can be easily determined. That is, although a communication terminal user does not select a variety of information to determine the exchange rate, the communication terminal may receive and determine a variety of information necessary for determining an exchange rate. Thereby, the exchange rate may be easily determined. Furthermore, exemplary embodiments of the present invention provide the user with the convenience of a communication terminal that more precisely determines an exchange rate.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. An exchange rate determining method of a communication terminal, the method comprising:
receiving first country information from Subscriber Identity Module (SIM) information of a SIM card;
receiving second country information from a System Information Block (SIB) broadcast from an affiliated base station;
determining exchange rate information according to the first country information and the second country information;
selecting a first amount, corresponding to a first monetary unit;
determining a second amount, corresponding to a second monetary unit, from the selected first amount using the exchange rate information; and
displaying the second amount.

2. The method of claim 1, wherein the determining of the exchange rate information is performed in an exchange rate determining mode.

3. The method of claim 1, wherein the determining of the exchange rate information comprises:
receiving, when power is on, the first country information; and
receiving the second country information in an exchange rate determining mode.

4. The method of claim 1, wherein the determining of the exchange rate information comprises:
determining the first monetary unit corresponding the first country information and the second monetary unit corresponding the second country information; and
determining exchange rate information between the first monetary unit and the second monetary unit.

5. The method of claim 1, wherein the determining of the exchange rate information comprises:
transmitting an exchange rate information request signal, including the first country information and the second country information, to an exchange rate server that stores an exchange rate information list; and
determining exchange rate information, according to the first country information and the second country information, from an exchange rate information response signal transmitted from the exchange rate server.

6. A communication terminal comprising:
a Subscriber Identity Module (SIM) card for storing SIM information comprising first country information;
a Radio Frequency (RF) communication unit for receiving a System Information Block (SIB) comprising second country information broadcast from an affiliated base station, when power is supplied to the communication terminal;
a controller for determining exchange rate information according to the first country information and the second country information, in an exchange rate determining mode, and for determining a second amount, corresponding to a second monetary unit, from a first amount, corresponding to a first monetary unit, using the exchange rate information when the first amount is selected; and
a display unit for displaying the second amount.

7. The communication terminal of claim 6, wherein the controller receives the first country information and the second country information in the exchange rate determining mode.

8. The communication terminal of claim 6, wherein the controller receives the first country information when power is supplied to the communication terminal and the second country information in the exchange rate determining mode.

9. The communication terminal of claim 6, wherein the controller determines the first monetary unit corresponding the first country information and the second monetary unit corresponding the second country information, and determines exchange rate information between the first monetary unit and the second monetary unit.

10. The communication terminal of claim 6, wherein the controller transmits an exchange rate information request signal, comprising the first country information and the second country information, to an exchange rate server that stores an exchange rate information list, in the exchange rate determining mode, and determines exchange rate information, according to the first country information and the second country information, from an exchange rate information response signal transmitted from the exchange rate server.

11. The communication terminal of claim 6, wherein the controller transmits an exchange rate information request signal to an exchange rate server that stores an exchange rate information list, in an exchange rate information storing mode.

12. The communication terminal of claim 11, wherein the controller stores an exchange rate information list of an exchange rate information response signal transmitted from the exchange rate server.

13. The communication terminal of claim 12, wherein the controller determines exchange rate information, according to the first country information and the second country information, from the exchange rate information list, in the exchange rate determining mode.

14. A communication system comprising:
a base station for broadcasting a System Information Block (SIB) comprising second country information;
an exchange rate server for storing an exchange rate information list comprising the exchange rate information according to the first country information and the second country information; and
a communication terminal comprising:
a Subscriber Identity Module (SIM) card for storing SIM information comprising first country information;
a Radio Frequency (RF) communication unit for receiving the SIB when power is supplied to the communication terminal; and
a controller for determining exchange rate information according to the first country information and the second country information, in an exchange rate determining mode, and for determining a second amount corresponding to a second monetary unit of the second country information from a first amount corresponding to a first monetary unit of the first country information using the exchange rate information, when the first amount is selected, and a display unit for displaying the second amount.

15. The communication system of claim 14, wherein the controller determines the first monetary unit corresponding the first country information and the second monetary unit corresponding the second country information, and determines exchange rate information between the first monetary unit and the second monetary unit.

16. The communication system of claim 15, wherein the controller transmits an exchange rate information request signal, comprising the first country information and the second country information, to an exchange rate server that stores an exchange rate information list, in the exchange rate determining mode, and determines exchange rate information, according to the first country information and the second country information, from an exchange rate information response signal transmitted from the exchange rate server.

17. The communication system of claim 16, wherein the controller transmits an exchange rate information request signal to an exchange rate server that stores an exchange rate information list, in an exchange rate information storing mode, stores an exchange rate information list of an exchange rate information response signal transmitted from the exchange rate server, and detects exchange rate information, according to the first country information and the second country information, from the exchange rate information list, in the exchange rate determining mode.
